(19) United States
(12) Patent Application Publication
(10) Pub. No.: US 2024/0137956 A1
(43) Pub. Date: Apr. 25, 2024

(54) METHOD FOR MANAGING RADIO RESOURCES IN A CELLULAR NETWORK BY MEANS OF A HYBRID MAPPING OF RADIO CHARACTERISTICS

(71) Applicant: COMMISSARIAT A L'ENERGIE ATOMIQUE ET AUX ENERGIES ALTERNATIVES, Paris (FR)

(72) Inventor: Mohamed SANA, Grenoble Cedex 9 (FR)

(73) Assignee: COMMISSARIAT A L'ENERGIE ATOMIQUE ET AUX ENERGIES ALTERNATIVES, Paris (FR)

(21) Appl. No.: 18/484,081

(22) Filed: Oct. 10, 2023

(30) Foreign Application Priority Data
Oct. 11, 2022 (FR) 22 10430

(51) Int. Cl. H04W 72/50; H04L 41/16

(52) U.S. Cl. CPC H04W 72/50; H04L 41/16

(57) ABSTRACT

The present invention relates to a method for managing radio resources in a cellular network. For each node of interest (Nⱼ) of the network, a set (Vⱼ(t)) of neighbouring nodes is determined. Each neighbouring node (Nᵢ∈Vⱼ(t)) performs a local observation of its environment (oᵢ(t,f)) and extracts thereform a plurality of radio characteristics, then encodes each of these radio characteristics in the form of a message (m_{i,j}^{k}(t,f)) which is transmitted to the node of interest. The node of interest then generates a local mapping (Φⱼ^{k}(t,f)) of each radio characteristic by aggregating the messages encoding this characteristic. Afterwards, the different local mappings are fused using fusion parameters so as to provide a hybrid local mapping (Φⱼ^{a}(t,f)) of the radio characteristics. The node of interest decides at all times to perform an action (aⱼ(t)) amongst a finite set (A) of possible actions, based on said hybrid local mapping and on a radio resource management strategy defined by a conditional probability parameterised distribution of each action (π_{j,θ}(aⱼ(t)|Φⱼ^{a}(t,f)). The set of fusion parameters as well as the set (θ) of the parameters of the conditional probability distribution undergo a reinforcement learning so as to maximise a reward over time, dependent on an objective function of the network.

### TECHNICAL FIELD

The present invention relates to the field of cellular networks and more particularly the management of radio resources or RRM (Radio Resource Management) in such a network. It also relates to the field of artificial intelligence and more particularly that of distributed learning (Distributed Learning).

### PRIOR ART

With the deployment of 5^{th} generation (5G) cellular networks, the techniques for managing radio resources have evolved to take account of new use cases involving highly heterogeneous services in terms of quality-of-service (QoS). Furthermore, most 5G networks are themselves heterogeneous by nature, these generally involving a superimposition of a dense layer of small cells or SBS (Small cell Base Stations) operating in particular in the millimetric band, intended to ensure a short distance and high-rate coverage, and of a less dense layer of macro-cells or MBS (Macro cell Base Stations), operating in the sub-6 GHz band, intended to ensure continuous coverage. This heterogeneity leads to a higher complexity of the management of the radio resources or RRM.

In general, the management of the radio resources is performed by maximising or by minimising a given objective function. Thus, depending on the considered strategy, one could, for example, maximise the quality-of-source (QoS) of some communications of the network, minimise the frequency of the handover operations, minimise the latency of some communications, or minimise the energy consumption of the mobile terminals and/or of the base stations. The management of the resources takes place at different levels in the network, for example in the allocation of transmission resources (time intervals, frequencies, codes), the association of the user terminals (UEs) with the base stations, the assignment/the configuration of beams, the allocation of power, the handover mechanism, the dynamic deployment of base stations or of relays, the terminal location, etc.

For simplicity, flexibility and scalability, the radio resource management methods generally involve a radio characteristic mapping representing the propagation conditions and/or the spectral activity in different sub-bands, at different points of the geographic area in which the network is deployed. These characteristics are conventionally obtained based on state information of the channel or CSI (Channel State Information) collected by the different user terminals at different points, at different frequencies and different periods. The radio characteristics thus mapped then allow estimating the interference levels, the properties of the propagation channels as well as the topology of the network.

Different mappings of radio characteristics, more simply called radio mappings, are known in the prior art.

For example, a mapping of the received signal strength or RSS (Received Signal Strength) of a plurality of access points (or, conversely the strength of the received signal originating from a source by a plurality of receivers) is commonly used in radio fingerprint location methods (radio fingerprinting). An example of application of RSS mapping to dynamically deploy relays in a network is described in the article by J. Chen entitled “Learning radio maps UAV-aided wireless networks: a segmented regression approach” published in Proc. of IEEE Int'l Conf. on Communications, May 2017, pp. 1-6.

The article by S. Bi et al. entitled “Engineering radio map for wireless resource management” published in IEEE Wireless Communications, February 2019, suggests generating a power spectral density mapping or PSD (Power Spectral Density) by superimposition of local mappings obtained at different emission points. However, this mapping method requires having a large number of nodes to obtain an accurate mapping of the PSD.

Finally, the article by C. Studer et al. entitled “Channel charting: locating users within the radio environment using channel state information” published in IEEE Access, vol. 4, 2016, pp. 1-17 describes a non-supervised method for learning a radio mapping (herein a channel characteristic mapping), based on an acquisition of the information CSI collected by the different terminals. The channel characteristic mapping is learnt in a representation space (embedding) with a reduced dimension ( [symbol] ^{D′}) compared to the geometric space ( [symbol] ^{D}), while preserving the local geometric relationships. More specifically, physically close points in the geometric space are transformed into neighbouring points in the representation space (continuity constraint). Afterwards, the channel characteristic mapping in the representation space may be used by a base station to make handover decisions.

Nonetheless, the mapping of channel characteristics suggested in this article contains relatively poor information. Thus, it cannot be used in a satisfactory manner for the management of the radio resources of the network. Furthermore, the aforementioned continuity constraint may prove to be unsuitable in some cases. Indeed, mobile terminals located proximate to one another could have radically different channel characteristics while, on the contrary, remote mobile terminals could have relatively similar channel characteristics. What is more, the generation of a mapping of these characteristics is generally carried out in a centralised manner, for example within a computing server, which, on the one hand, requires the exchange of a large number of messages of measurements within the network and reduces as much the useful bitrate of the communications, and, on the other hand, does not allow effectively following the local variations of the characteristics due to the heterogeneity of the network. Finally, the obtained channel mapping is specific to a given environment and to a given frequency band: a change in the environment or in the frequency band (for example from the sub-6 GHz band to the millimetric band or vice versa) consequently requires launching a completely new learning campaign.

Consequently, the object of the present invention is to provide a method for managing radio resources based on an enriched (or augmented) radio mapping, which can easily take into account the heterogeneity of the network without resorting to large computing infrastructures or affecting the useful bitrate of the communications, and which does not require any new complete learning phase in case of change in the environment or in the topology of the network.

### DISCLOSURE OF THE INVENTION

The present invention is defined by a method for managing radio resources in a cellular network comprising a plurality of nodes, wherein for each node of interest (Nⱼ) of the network, a neighbourhood (Vⱼ(t)) of this node of interest is determined, each node of said neighbourhood (Nᵢ∈Vⱼ(t)) performing a local observation of its environment (oᵢ(t, f)) and by extracting a plurality of radio characteristics, said method being remarkable in that:
each neighbouring node encodes each of the radio characteristics in the form of a message (m_{i,j}^{k}(t,f)) and transmits this message to the node of interest;
the node of interest generates a local mapping (Φⱼ^{k}(t, f)) of each radio characteristic by aggregating the messages encoding this characteristic;
the node of interest fuses the local mappings by means of fusion parameters to generate a hybrid local mapping (Φⱼ^{a}(t, f)) of the different radio characteristics;
the node of interest decides at all times to perform an action (aⱼ(t)) amongst a finite set (A) of possible actions, based on said hybrid local mapping and on a radio resource management strategy defined by a conditional probability parameterised distribution of each action (π_{j,θ}(aⱼ(t)|Φⱼ^{a}(t, f))), the set of fusion parameters as well as the set (θ) of the parameters of the conditional probability distribution undergoing a reinforcement learning so as to maximise a reward over time, dependent on an objective function of the network.

Advantageously, the reward to be maximised corresponds to a sum of bitrates or quality-of-service levels over communications of the network to be maximised, or a handover frequency or an energy consumption to be minimised.

The neighbourhood of the node of interest may be defined as a set of neighbouring nodes of the network considering a similarity metric operating in a representation space of the local observations.

Alternatively, said neighbourhood of the node of interest is determined by means of a classifier trained beforehand, operating in a representation space of the local observations.

Advantageously, the node of interest decides to perform an action at a time point only to the extent that one of the local mappings of a radio characteristic at this time point differs from the local mapping of the same radio characteristic at the previous time point, the difference between the two local mappings being measured using a Kullback-Leibler divergence.

Alternatively, the node of interest decides to perform an action at a time point only to the extent that the hybrid local mapping at this time point differs from the hybrid local mapping at the previous time point, the difference between the two hybrid mappings being measured using a Kullback-Leibler divergence.

Advantageously, the fusion of the local radio mappings uses an attention mechanism with H heads, with H<K where K is the number of radio characteristics.

In this case, the hybrid local mapping may be obtained by means of Φⱼ^{a}(t, f)=W_{ϕ}·[αⱼ^{h}ϕⱼ^{h}(p, t, f); h=1, . . . , H]^{T} where αⱼ^{j}=(α_{i,j}^{h}; i=1, . . . , Pⱼ) is the score between a query qⱼ^{h} of the node Nⱼ and of the keys associated with the different observations derived from the nodes of the neighbourhood Vⱼ(t), of the node of interest, ϕⱼ^{h}(p, t, f) is the local mapping value of the characteristic h at the point p, at the time point t and at the frequency f, and W_{ϕ} is a Pⱼ×H size matrix where Pⱼ is the number of nodes of the neighbourhood Vⱼ(t).

The query of the node of interest may be expressed by a vector qⱼ^{h}=W_{q,j}^{h}oⱼ^{T} or where W_{q,j}^{h} is a n×Ω size matrix where n is the dimension of the representation space of the characteristics and Ω is the size of the observation vectors and the keys associated with the different observations derived from the nodes Nᵢ of Vⱼ(t) may be expressed by the vectors k_{i,j}^{h}=W_{k,j}^{h}oⱼ^{T}.

Finally, the score between the query qⱼ^{h} of the node Nⱼ and a key associated with a node Nᵢ of the neighbourhood Vⱼ(t) may be calculated by means of

$$\\ {α}_{i , j}^{h} = softmax ( \frac{{q}_{j}^{h} \cdot {k}_{i , j}^{h}}{\sqrt{n}} )$$

where “⋅” represents the scalar product.

### BRIEF DESCRIPTION OF THE DRAWINGS

Other features and advantages of the invention will appear upon reading a preferred embodiment of the invention, described with reference to the appended figures wherein:

FIG. 1 schematically shows a service for forwarding messages between the nodes of the same neighbourhood within the network, used in the context of the present invention;

FIG. 2 schematically illustrates an example of combination of radio local characteristic mappings which could be used in the radio resource management method according to the present invention;

FIG. 3 schematically shows the architecture of a node of the network allowing implementing a radio resource management method according to an embodiment of the present invention;

FIG. 4 schematically shows a flowchart of the radio resource management method according to an embodiment of the present invention;

FIG. 5 details the step of determining the neighbourhood of a node in the flowchart of FIG. 4.

### DETAILED DISCLOSURE OF PARTICULAR EMBODIMENTS

Next, a cellular network composed of a plurality of base stations will be considered. Still talking in general terms and for only illustrative purposes, we will assume that this cellular network is heterogeneous. By heterogeneous cellular network, we mean a network resulting from the superimposition of a small cell layer (SBS) with a short coverage, yet potentially capable of offering to each UE a high bitrate, and of a macro-cell layer (MBS), guaranteeing the continuity of coverage of the network by offering a larger coverage. A typical example of application is that of a 5G network wherein the cells SBS operate in the millimetric band and the cells MBS operate in the sub-6 GHz band. Nonetheless, a person skilled in the art should understand that the combination method according to the invention applies to any cellular network, whether homogeneous or heterogeneous.

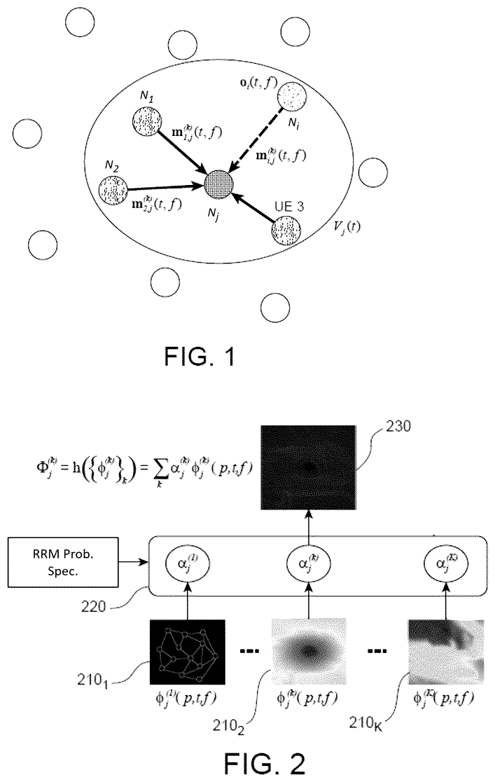

An underlying idea of the present invention is to perform a learning of a radio resource management policy based on a hybrid local mapping of a plurality of radio characteristics. This mapping is obtained in a distributed manner rather than centralised like in the prior art. To do so, the present invention uses a service for forwarding messages between neighbouring messages, as illustrated in FIG. 1.

The nodes of the network, denoted Nᵢ, i=1, . . . , P may consist of user terminals (UE), base stations (BS) or relays. In FIG. 1, the nodes belonging to the neighbourhood Vⱼ(t), of a node of interest Nⱼ, for example a user terminal, have been illustrated, said neighbourhood being obtained by means of a similarity metric described later on. As indicated by the notation, the neighbourhood Vⱼ(t) depends on time t to the extent that the environment of the node Nⱼ could vary, either the latter moves in the network, or some nodes come out or in the area where Nⱼ is located, or because of the evolution of the propagation environment itself (for example movement of an obstacle to propagation), or because of a combination of these different causes, and that being so without limitation.

Each node belonging to the neighbourhood of Nⱼ, namely Nᵢ∈Vⱼ(t), performs a local observation, denoted oᵢ(t, f), of its radio environment in the form of a measurement of at least one parameter or radio signal.

In general, such a local observation may be in a vector form, for example a row line oᵢ(t, f), each element of the observation vector corresponding to the measurement of a parameter or of a radio signal, and may depend on the time point, t, and on the frequency, f, at which (and possibly on the frequency band in which) it is carried out. This local observation may comprise a received signal measurement RSS, an angle of arrival of a received signal, an angle of departure of an emitted signal, a channel estimate or equivalently, a channel state information CSI, a quality-of-service estimate QoS, an interference level, a mobility class (in a 5G system) or a traffic density query (in a 5G system).

Next, it will be assumed that each node is capable of extracting K radio characteristics from its local observations. These radio characteristics may relate for example to the topology of the network, to the interference level, to the traffic density, etc. These radio characteristics are encoded in the form of messages which are transmitted to the node Nⱼ. More specifically, in the case of FIG. 1, each node Nᵢ∈Vⱼ(t) performing a local observation, oᵢ(t, f), extracts radio characteristics k=1, . . . , K therefrom and encodes each of them in the form of a message m_{i,j}^{k}(t, f) that it transmits to the node Nⱼ, namely:

[Math. 1]

m_{i,j}^{k}(t, f)=gⱼ^{k}(oᵢ(t, f)) (1)

As a general rule, the encoding function gⱼ^{k}(⋅) depends on the node Nⱼ the neighbourhood of which is considered and on the considered radio characteristic. It may be viewed as a pre-filtering function relating to the characteristic k intended to extract from the local observation oᵢ(t, f) a piece of information relating to this characteristic. This encoding function may be in different forms depending on the considered observation type and considered characteristic. For example, it may be defined by an association operation (clustering), a projection onto a geometric variety, in particular onto an affine variety relating to the considered characteristic, a multiplication by a filtering matrix, a mapping table, a neural network.

The node of interest Nⱼ aggregates the messages relating to the same characteristic k, received from its neighbours and calculates the value taken by a local mapping variable representing this characteristic, into a plurality of positions p=1, . . . , Pⱼ(t) with Pⱼ(t)=Card(Vⱼ(t)), at the time point t and at the frequency f, namely:

[Math.2]

ϕⱼ^{k}(p, t, f)=σₖ{m_{i,j}^{k}(t, f), ∀i∈Vⱼ(t)} (2)

where σₖ{⋅} is an aggregation function, invariable by permutation of the indices i (the order of the nodes in the neighbourhood being unimportant) and scalable, to the extent that the aggregation function should be independent of the number of nodes in the neighbourhood Vⱼ(t). Next, for simplicity, we will adopt the notation Pⱼ instead of Pⱼ(t), it being understood that the number of neighbouring nodes of the node of interest Nⱼ is generally time-dependent. The set of values ϕⱼ^{k}(p, t, f) for the different positions p=1, . . . , Pⱼ gives a local mapping (local feature map), Φⱼ^{k}(t, f) of the characteristic k at the time point t and the frequency f, in the neighbourhood Vⱼ(t), where Φⱼ^{k}(t, f) is a vector with the size Pⱼ(t)=Card(Vⱼ(t)). More generally, the values ϕⱼ^{k}(p, t, f) are not necessarily scalar by consist of vectors with a dimension n (n being the dimension of the representation space of the radio characteristics), the mapping then being defined by a Pⱼ×n size matrix Φⱼ^{k}(t, f). Where appropriate, one could provide for a matrix size Π×n independent of the considered node of interest, Π≥Pⱼ with the matrix then being sparse (sparse) or having values interpolated for the points that do not correspond to positions of nodes of the neighbourhood. Next, we will however assume, yet without loss of generality, that the matrices Φⱼ^{k}(t, f) have a size Pⱼ×n.

For example, the aggregation function σₖ(⋅) of the different messages may consist of a concatenation, a max-pooling operation, a sum of projections, and possibly a self-attention mechanism (self-attention) as defined in the article by A. Vaswani et al. entitled “Attention is all you need”, published in Proceedings of NIPS 2017, 6.12.2017.

Where appropriate, the encoding and combination operations could be carried out together in a graph neural network or GNN (Graph Neural Network), as described in the article by J. Zhou et al. entitled “Graph neural networks: a review of methods and applications” published in A I Open, vol. 1, pp. 57-81, for example in a graph attention network. In such a case, the nodes of the graph consist of nodes of the cellular network, each node having a piece of information corresponding to its local observation oᵢ(t, f) and the segments of the graph represent the exchanged messages m_{i,j}^{k}(t, f).

Afterwards, the local mappings Φⱼ^{k}(t, f) of the different characteristics, k=1, . . . , K, are fused to obtain a hybrid local mapping of these characteristics, also called augmented mapping, Φⱼ^{a}(t, f). The manner in which the fusion is carried out depends on the objective function to be optimised (maximised or minimised) for a given radio resource management policy. For example, it could consist in maximising a sum of bitrates (over different communications), maximising a quality-of-service, reducing the handover frequency, reducing the energy consumption in a network periphery computing scenario or MEC (Mobile Edge Computing).

According to a first embodiment, the fusion may be obtained by means of a simple sum, and possibly of a weighted sum. In other words:

$$\\ \begin{matrix}[ Math . 3 ] & \\ {Φ}_{j}^{a} ( t , f ) = {\sum }_{k = 1}^{K} {a}_{j}^{k} {Φ}_{j}^{k} ( t , f ) & ( 3 )\end{matrix}$$

where aⱼ^{k}, k=1, . . . , K are strictly positive real numbers. This supposes that, in this case, all matrices Φⱼ^{k}(t, f) have the same size Π×n.

According to a second embodiment, the augmented mapping may be obtained by means of a sum of matrix products:

$$\\ \begin{matrix}[ Math . 4 ] & \\ {Φ}_{j}^{a} ( t , f ) = {\sum }_{k = 1}^{K} {A}_{j}^{k} {Φ}_{j}^{k} ( t , f ) & ( 4 )\end{matrix}$$

where Aⱼ^{k}, k=1, . . . , K are Π×Pⱼ size matrices.

According to a third embodiment, the augmented mapping is obtained by means of an attention mechanism. Recall that an attention mechanism schematically aims to find in a sequence of inputs, those (herein the radio characteristics) that have a given connection or correlation to best predict an output. An attention mechanism (cf. the aforementioned article by Vaswani et al.) implements a query vector (query), a key vector (key) and a value vector (value). For a given query and for each key associated with a value, an attention score is calculated which represents the degree of relevance of this key for the query, the result of the query then consisting in weighting the different values by weights representative of the associated scores.

In this case, a query of the node Nⱼ is formed for each characteristic h amongst H<K characteristics by means of:

[Math.5]

qⱼ^{h}=W_{q,j}^{h}oⱼ^{T} (5)

where W_{q,j}^{h} is a n×Ω size matrix where n is the dimension of the representation space of the characteristics and Ω is the size of the observation vectors.

More specifically, the augmented local mapping is then obtained by:

[Math.6]

Φⱼ^{α}(t, f)=W_{ϕ}·[αⱼ^{h}ϕⱼ^{h}(p, t, f); h=1, . . . , H]^{T} (6)

where αⱼ^{h}=(α_{i,j}^{h}; i=1, . . . , Pⱼ) is the score between the query qⱼ^{h} of the node Nⱼ and the keys associated with the different observations derived from the nodes of Vⱼ(t), namely:

$$\\ \begin{matrix}[ Math . 7 ] & \\ {α}_{i , j}^{h} = softmax ( \frac{{q}_{j}^{h} \cdot {k}_{i , j}^{h}}{\sqrt{n}} ) & ( 7 )\end{matrix}$$

where k_{i,j}^{h}=W_{k,j}^{h}oⱼ^{T} is the key vector associated with the different observations derived from the nodes of Vⱼ(t) and ⋅ represents the scalar product;
ϕⱼ^{h}(p, t, f)=[v_{i,j}^{h}(t, f); i=1, . . . , Pⱼ]^{T} is a Pⱼ×n size matrix where v_{i,j}^{h}(t, f)=W_{v,j}^{h}oⱼ^{T} is the value vector associated with these same observations;
W_{Φ} is a Pⱼ×H size matrix where H is the number of attention heads, [αⱼ^{h}ϕⱼ^{h}(p, t, f); h=1, . . . , H] is a n×H size matrix and consequently the mapping Φⱼ^{a}(t, f) is a Pⱼ×n size matrix.

The coefficient aⱼ^{k} in the first embodiment, the matrices Aⱼ^{k} in the second embodiment, as well as the matrices W_{q,j}^{h}, W_{k,j}^{h}, W_{v,j}^{h}, W_{Φ} involved in the third embodiment, collectively called fusion parameters, are advantageously determined by means of a reinforcement learning as described later on.

FIG. 2 schematically shows a combination of radio local mappings according to the aforementioned first embodiment.

In 210₁, 210₂ . . . , 210_{K}, the radio local mappings obtained by the node Nⱼ have been represented based on the messages received from its neighbouring nodes. For example, the mapping 210₁ may give the local topology of the network, the mapping 210₂ may give an RSS piece of information of the signal received from Nⱼ, etc.

These mappings are weighted by means of weighting coefficients aⱼ^{k} which would have been determined beforehand in a learning phase, this learning depending on the objective function, and then combined in 220.

The hybrid (or augmented) mapping 230, resulting from the combination of the different radio characteristic mappings, is used to make radio resource management decisions.

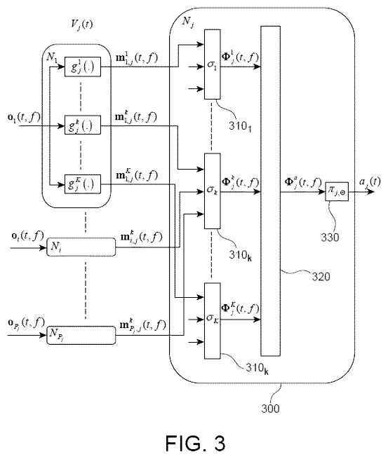

FIG. 3 schematically shows the architecture of a node of the network allowing implementing a radio resource management method according to an embodiment of the present invention.

The considered node, 300, is the node of interest Nⱼ of FIG. 1. Recall that each node Nᵢ, i≠j, of the neighbourhood Vⱼ(t) performs an observation oⱼ(t, f) of its environment, extracts therefrom a piece of information relating to the radio characteristic k then transmits a message m_{i,j}^{k}(t, f)=gⱼ^{k}(oᵢ(t, f)) to the node

The node 300 has a plurality K of aggregation modules 310ₖ, k=1, K each aggregation module 310ₖ aggregating the messages m_{i,j}^{k}(t, f), i=1, . . . , Pⱼ, received from the nodes of Vⱼ(t) to generate a local mapping of the radio characteristic k. This mapping is stored in an associated local memory (not shown).

Afterwards, the radio local mappings relating to the different characteristics are fused in the combination module 320 to provide a hybrid (or augmented) local mapping Φⱼ^{a}(t, f).

The node 300 makes a decision relating to the management of the radio resources in the decision module 330, so as to optimise an objective function. For example, the combination and decision modules may be made by made by means of neural networks.

According to one embodiment, the decision module 330 makes a new decision only when a variation has occurred in one of the mappings Φⱼ^{k}(t, f), k=1, . . . , K.

The parameters of the fusion modules and of the decision module are determined by learning, advantageously by means of a reinforcement learning, as described later on.

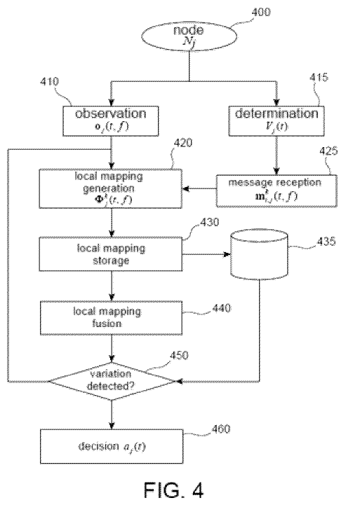

FIG. 4 schematically shows a flowchart of the radio resource management method according to an embodiment of the present invention.

A node of interest Nⱼ of the network is considered again.

This node 400 performs in step 410 a local observation of its radio environment, oⱼ(t, f). It extracts a piece of information relating to each radio characteristic k=1, . . . , K then transmits the messages m_{j,l}^{k}(t, f)=gₗ^{k}(oⱼ(t, f)) to the nodes Nₗ for which Nⱼ∈Vₗ(t).

In parallel, the node Nⱼ determines in step 415 its neighbourhood Vⱼ(t) at the time point t considering a metric as described later on, and receives in 425 the messages m_{i,j}^{k}(t, f) of the nodes of the network belonging to this neighbourhood.

The node Nⱼ generates in 420 the local mappings Φⱼ^{k}(t, f), k=1, . . . , K of the different radio characteristics and fuses them in 440 to obtain the augmented local mapping, Φⱼ^{a}(t, f).

In parallel, the updated local mappings Φⱼ^{k}(t, f) are stored in 430 in a local memory 435 of the node, Nⱼ.

The node Nⱼ makes a radio resource management decision in 460, different options are possible:

First of all, a decision relating to the management of the radio resources may be made at each time increment. Alternatively, such a decision will be made only if one of the current mappings Φⱼ^{k}(t, f), k=1, . . . , K significantly differs from that generated for the same characteristic at the previous time point Φⱼ^{k}(t−1, f), which option is represented by the test 450. Still alternatively, such a decision will be made only if the current hybrid mapping Φⱼ^{a}(t, f) significantly differs from that relating to the previous time point Φⱼ^{a}(t−1, f). Finally, alternatively, such a decision will be made only if the hybrid mapping observed over a given time window significantly differs from that observed at a time point preceding this window. In any case, the detection of a variation of the mapping could be obtained based on the K-L divergence (Kullback-Leibler divergence) between two successive mappings. For example, in the first case, a significant variation will be detected if:

[Math.8]

∃k∈{1, . . . , K} tel que D_{KL}(Φⱼ^{k}(t, f)∥Φⱼ^{k}(t−1, f))>ε_{TH} (8)

where D_{KL} is the K-L divergence and ε_{TH} is a positive real number representing a predetermined variation threshold.

The radio resource management policy followed by the node Nⱼ is determined by a reinforcement learning. Recall that a reinforcement learning method is a machine learning method in which an autonomous agent, immersed in an environment, learns actions to perform from experiences, so as to optimise a cumulated reward over time. The agent makes decisions according to its state in the environment according to a Markov decision process and the environment provides it, in return, with rewards depending on the actions it has performed at any time.

In this case, the agent is a node of the network, in this instance the node Nⱼ, and the state of the node in the environment Vⱼ(t) is represented by the augmented local mapping Φⱼ^{a}(t, f). The learning is herein intended to determine the radio resource management strategy π_{j,θ}(aⱼ(t)|Φⱼ^{a}(t, f)), i.e. the probability for the node to decide to perform the action aⱼ(t)∈A where A is the set of possible actions when the augmented local mapping is Φⱼ^{a}(t, f). The set θ of the parameters parameterising the probability distribution π_{j, θ}(aⱼ(t)|Φⱼ^{a}(t, f)), as well as the fusion parameters, for example the matrices W_{q,j}^{h}, W_{k,j}^{h}, W_{v,j}^{h}, W_{Φ} involved in the third embodiment are learnt by means of an end-to-end learning (end-to-end), i.e. covering both the combination module 330 and the decision module 340. The learning may be carried out, in a manner known per se, by a strategy gradient method (policy gradient method) described in the book of R. S. Sutton entitled “Reinforcement Learning” published by MIT Press in 2018.

The above-described radio resource management method supposes that each node Nⱼ could determine its neighbourhood (cf. step 415), and therefore the nodes which will participate in the message forwarding service.

The neighbourhood Vⱼ(t) of the node may be determined by selecting (or by subsampling) from among the nodes of the network, or from a subset thereof, those that meet a given metric δ, operating in a representation space of the local observations:

[Math.9]

Vⱼ(t)={Nᵢ|δ(oᵢ, oⱼ)≤d:Nᵢ∈U} (9)

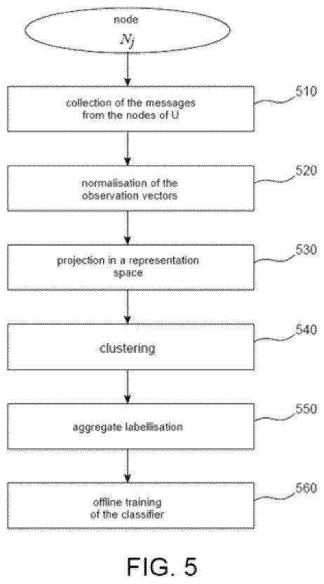

The metric δ may be cosine similarity (cosine similarity) based on a scalar product of normalised vectors. Alternatively, δ may be considered as a classification process where δ(oᵢ, oⱼ) defines the probability that the observation oⱼ belongs to the same class as oᵢ. The classification operator may be trained online in a centralised and supervised manner as indicated in FIG. 5.

In step 510, the node Nⱼ collects the local observations of the set U of the nodes of the network or of a subset consisting for example of those that are within the receiving range of Nⱼ. These local observations are represented by vectors oᵢ.

Afterwards, these vectors undergo a preprocessing (for example a normalisation) in 520 before being projected into a representation space with a reduced dimension in 530.

A K-means type clustering algorithm, 540, then allows grouping together the nodes in the form of aggregates and then assigning, 550, the same label to the nodes of the same aggregate. Finally, a classifier may be trained offline (offline) in a supervised manner on the nodes-labels pairs thus created, 560.

Once trained, the classifier can determine for a given node, Nⱼ, the nodes of the network or of a subset thereof which belong to the same aggregate as Nⱼ. These nodes form the neighbourhood Vⱼ(t) of Nⱼ.

The method for managing the radio resources of a cellular network based on an augmented local mapping at each node of the network and possibly only at nodes of a given type (base stations BS, SBS, MBS, relays, etc.) allows making decisions in a distributed manner while taking the heterogeneity of the latter into account. What is more, once the set of parameters θ has been learnt for a frequency range (for example sub-6 GHz), the latter may be transferred to combination and decision modules operating in another (millimetric) frequency range for a pursuit and an adaptation of the learning at this other range. Thus, the transferability of the parameters allows accelerating the learning phase in a new environment.

For illustration, we will describe hereinafter two examples of application of a radio resource management method according to the present invention.

The first example relates to the association of user equipment (UEs) in a 5G network. Recall that an association method aims to determine, for each mobile terminal, the base station (in other words the cell) that should serve it, given the needs of all users (bitrate, signal-to-noise ratio, latency, etc.) and the constraints related to the base stations (maximum emission power, interference level, available bandwidth, etc.). It is assumed that the 5G network has Nₘ small cells (small cells) equipped with base stations SBS operating in the millimetric band and Nₛ macro-cells (macro cells) equipped with base stations MBS in the sub-6 GHz band. The set of user terminals is herein denoted U(t) and that of the access points, with the cardinal Nₘ+Nₛ is denoted S.

Each user terminal or UE Nⱼ∈U(t) may perform an action aⱼ(t)∈A corresponding to a query for associating with a base station (SBS or MBS). A is the set of possible association queries, herein corresponding in a biunivocal manner to the set S of base stations.

The observations of the different UEs Nᵢ∈Vⱼ(t) are given by the vectors:

[Math.10]

oᵢ(t, f)=[R(t−1), Dₜ(t), {RSS_{i,b}(t, f), AoA_{i,b}(t, f), I_{i,b}(t−1, f), QoS_{i,b}(t−1, f)}_{b∈S}] (10)

where R(t−1) is the total capacity of the network at the previous time point t−1, Dᵢ(t) is the bitrate required by the mobile terminal Nᵢ at the time point t, RSS_{i,b}(t, f) is the power of the received signal by the UE Nᵢ of the base station b∈S at the time point t and at the frequency f, AoA_{i,b}(t, f) is the angle of arrival of the signal received from this base station, I_{i,b}(t−1, f) is the measured interference level and QoS_{i,b}(t−1, f) the quality-of-service level, as perceived at the previous time point. It should be noted that the total capacity of the network R(t) is not known at the observation time to the extent that the decision to associate Nⱼ is still not made, it is therefore its value at the previous time point t−1 that is taken into account in the observation vector. The same apply for the interference and quality-of-service levels.

Afterwards, the neighbourhood Vⱼ(t) is determined as described before with reference to FIG. 5.

The messages m_{i,j}^{k}(t, f)=gⱼ^{k}(oᵢ(t, f)) received by the node Nⱼ are taken into account by means of an attention mechanism with several (H) heads. The message transmitted by the node Nⱼ to the node Nᵢ corresponding to the characteristic h∈{1, . . . , H} is defined by:

[Math.11]

m_{i,j}^{h}(t, f)=(k_{i,j}^{h}, v_{i,j}^{h}) (11)

with k_{i,j}^{h}=W_{k,j}^{h}oⱼ^{T} and k_{i,j}^{h}=W_{k,j}^{h}oⱼ^{T} adopting the previous notations. The augmented local mapping Φⱼ^{a}(t, f) is obtained by fusioning the local mappings, by the expressions (6) and (7). The parameters θ parameterising the strategy π_{j,θ}(aⱼ(t)|Φⱼ^{a}(t, f)) are selected so as to maximise the reward over time, for example to maximise the bitrate or the QoS levels of the different communications, or to minimise the handover frequency.

The second example relates to the positioning of mobile access points or MAPs (Mobile Access Points) for example of the access points installed on drones or UAVs (Unmanned Aerial Vehicles) in a 5G network. Such mobile access points allow rapidly deploying and reconfiguring a network, for example in emergency situations or in a theatre of operations. The management of radio resources in such a context, in particular the number of drones and their positioning, is particularly complex because of the mobility of both the UEs and the MAPs.

In this example, it is assumed that the MAPs operate in the millimetric frequency range and are directly connected to the backhaul network (backhaul network). The network further comprises Nₛ base stations MBS in the sub-6 GHz band. For simplicity, it is considered that only one base station MBS (one single macro-cell) and a plurality Nₘ of mobile access points MAPs. Like before, the set of user terminals is denoted U(t), each user terminal is supposed to have 2 antennas enabling it to establish either a connection with a MAP or a connection with an MBS. The set of access points S has a cardinal Nₘ+1 (Nₘ MAPs and an MBS), the number of MAPs being selected equal to the number of aggregates, N_{c}(t), identified in the network. Hence, these aggregates may be referred to by C_{b}(t), b∈{1, . . . , N_{c}(t)}, each aggregate b consisting of user equipment Nⱼ, j∈C_{b}(t). Each mobile access point MAP_{b}, can make a decision a_{b}(t)∈A where A is the set of possible movement actions. For example, this set may consist of 6 incremental movements (positive and negative according to the 3 axes X,Y,Z) and of a stationary state (no movement at the time point t).

The environment of a mobile access point MAP_{b} consisting of the UEs Nⱼ, j∈C_{b}(t), each UE belonging to the aggregate b transmits to the node MAP_{b} a message relating to the characteristic h:

[Math.12]

m_{j,b}^{h}(t, f)=(k_{j,b}^{h}, v_{j,b}^{h}) (12)

where k_{j,b}^{h}=W_{k,b}^{h}oⱼ^{T} and v_{j,b}^{h}=W_{v,b}^{h}oⱼ^{T} are respectively the key vectors and value relating to MAP_{b}. The observation vector is oⱼ is given by oⱼ(t, f)={xⱼ(t), yⱼ(t), Rⱼ(t)} where (xⱼ(t), yⱼ(t)) are the spatial coordinates of the UE Nⱼ and Rⱼ(t) is the bitrate received by this UE.

The mobile access point MAP_{b} aggregates the messages received by means of an attention mechanism with several (H) heads and generates, for each radio characteristic h, a local mapping Φ_{b}^{h}(t, f)=[v_{j,b}^{h}, ∀j∈C_{b}(t)]^{T}. Afterwards, these local mappings are fused by means of an attention mechanism, as described with reference to the expressions (6) and (7), namely:

[Math.13]

Φ_{b}^{h}(t, f)=W_{Φ}·[α_{b}^{h}ϕ_{b}^{h}(p, t, f); h=1, . . . , H]^{T} (13)

where α_{b}^{h}=(α_{j,b}^{h}; ∀j∈C_{b}(t)) is the score between the query q_{b}^{h}=W_{q,b}^{h}o_{b}^{T} of the mobile access point MAP_{b}, where o_{b} denotes the local observation of MAP_{b} (namely its 3D location) and the key vectors associated with the different observations derived from the UEs of the aggregate b:

$$\\ \begin{matrix}[ Math . 14 ] & \\ {α}_{j , b}^{h} = softmax ( \frac{{q}_{b}^{h} \cdot {k}_{j , b}^{h}}{\sqrt{n}} ) & ( 14 )\end{matrix}$$

where, like before, n is the dimension of the representation space or the radio characteristics. This score reflects the correlation between the dynamics of the mobile access point and those of the UEs belonging to the aggregate.

Based on the augmented mapping Φ_{b}^{a}(t, f), the mobile access point MAP_{b} makes a decision a_{b}(t)∈A by means of the strategy π_{b,θ}(a_{b}(t)|Φ_{b}^{a}(t, f)).

The set θ of the parameters parameterising the probability distribution π_{b,θ}(a_{b}(t)|Φ_{b}^{a}(t, f)), as well as the fusion parameters, namely the matrices W_{q,b}^{h}, W_{k,b}^{h}, W_{v,b}^{h}, W_{Φ} are learnt by means of an end-to-end reinforcement learning, aiming to maximise a reward over time.

Like in the previous example, the maximisation of the reward may be expressed as a maximisation of the bitrates or of the QoS levels of the different communications, or as a minimisation of the handover frequency.

1. A method for managing radio resources in a cellular network comprising a plurality of nodes, wherein for each node of interest (Nⱼ) of the network, a neighbourhood (Vⱼ(t)) of this node of interest is determined, each node of said neighbourhood (Nᵢ∈Vⱼ(t)) performing a local observation of its environment (oᵢ(t,f)) and by extracting a plurality of radio characteristics, wherein:
each node of said neighbourhood encodes each of the radio characteristics in the form of a message (m_{i,j}^{k}(t,f)) and transmits this message to the node of interest;
the node of interest generates a local mapping (Φⱼ^{k}(t,f)) of each radio characteristic by aggregating the messages encoding this characteristic;
the node of interest fuses the local mappings by means of fusion parameters to generate a hybrid local mapping (Φⱼ^{a}(t,f)) of the different radio characteristics;
the node of interest decides at all times to perform an action (aⱼ(t)) amongst a finite set (A) of possible actions, based on said hybrid local mapping and on a radio resource management strategy defined by a conditional probability parameterised distribution of each action (π_{j,θ}(aⱼ(t)|Φⱼ^{a}(t,f))), the set of fusion parameters as well as the set (θ) of the parameters of the conditional probability distribution undergoing a reinforcement learning so as to maximise a reward over time, dependent on an objective function of the network.

2. The method for managing radio resources in a cellular network according to claim 1, wherein the reward to be maximised corresponds to a sum of bitrates or quality-of-service levels over communications of the network to be maximised, or a handover frequency or an energy consumption to be minimised.

3. The method for managing radio resources in a cellular network according to claim 1, wherein said neighbourhood of the node of interest is defined as a set of neighbouring nodes of the network considering a similarity metric operating in a representation space of the local observations.

4. The method for managing radio resources in a cellular network according to claim 1, said neighbourhood of the node of interest is determined by means of a classifier trained beforehand, operating in a representation space of the local observations.

5. The method for managing radio resources in a cellular network according to claim 1, wherein the node of interest decides to perform an action at a time point only to the extent that one of the local mappings of a radio characteristic at this time point differs from the local mapping of the same radio characteristic at the previous time point, the difference between the two local mappings being measured using a Kullback-Leibler divergence.

6. The method for managing radio resources in a cellular network according to claim 1, wherein the node of interest decides to perform an action at a time point only to the extent that the hybrid local mapping at this time point differs from the hybrid local mapping at the previous time point, the difference between the two hybrid mappings being measured using a Kullback-Leibler divergence.

7. The method for managing radio resources in a cellular network according to claim 1, wherein the fusion of the local radio mappings uses an attention mechanism with H heads, with H<K where K is the number of radio characteristics.

8. The method for managing radio resources in a cellular network according to claim 7, wherein the hybrid local mapping is obtained by means of Φⱼ^{a}(t,f)=W_{Φ}·[αⱼ^{h}ϕⱼ^{h}(p,t,f);h=1, . . . , H]^{T} where αⱼ^{h}=(α_{i,j}^{h}; i=1, . . . , Pⱼ) is the score between a query qⱼ^{h} of the node Nⱼ and of the keys associated with the different observations derived from the nodes of the neighbourhood Vⱼ(t), of the node of interest, ϕⱼ^{h} (p,t,f) is the local mapping value of the characteristic h at the point p, at the time point t and at the frequency f, and W_{Φ} is a Pⱼ×H size matrix where Pⱼ is the number of nodes of the neighbourhood Vⱼ(t).

9. The method for managing radio resources in a cellular network according to claim 8, wherein the query of the node of interest is expressed by a vector qⱼ^{h}=W_{q,j}^{h}oⱼ^{T} where W_{q,j}^{h} is a n×Ω size matrix where n is the dimension of the representation space of the characteristics and Ω is the size of the observation vectors and that the keys associated with the different observations derived from the nodes Nᵢ of Vⱼ(t) are expressed by the vectors k_{i,j}^{h}=W_{k,j}^{h}oⱼ^{T}.

10. The method for managing radio resources in a cellular network according to claim 9, wherein the score between the query qⱼ^{h} of the node Nⱼ and a key associated with a node Nᵢ of the neighbourhood Vⱼ(t) is calculated by means of
$$\\ {α}_{i , j}^{h} = softmax ( \frac{{q}_{j}^{h} \cdot {k}_{i , j}^{h}}{\sqrt{n}} )$$
where “⋅” represents the scalar product.
